(19) United States
(12) Patent Application Publication
(10) Pub. No.: US 2005/0098963 A1
(43) Pub. Date: May 12, 2005

(54) One-piece extrusion-resistant seal

(75) Inventor: John H. Olsen, Vashon, WA (US)

Correspondence Address: GRAYBEAL JACKSON HALEY LLP;Attention: Frederick A. Kaseburg, Suite 350, 155-108th Avenue NE, Bellevue, WA, 98004-5973, US

(73) Assignee: Omax Corporation

(21) Appl. No.: 10/702,353

(22) Filed: Nov. 6, 2003

(51) Int. Cl. F16J 15/02

(52) U.S. Cl. 277/628

(57) ABSTRACT

An extrusion-resistant seal having a deformable sealing part and an extrusion-resistant part. The seal includes a sealing part formed by melting and solidifying a first thermoplastic polymer, and an extrusion-resistant part formed by sintering a second thermoplastic polymer. The sealing part and the extrusion-resistant part may be consolidated into a one-piece structure. The second thermoplastic polymer includes fibers of the second thermoplastic polymer, which may include an oriented configuration, such as a woven configuration or a braided configuration. The sealing part has a first deformation value, and the extrusion-resistant part may have a second deformation value that is less than the first deformation value. Also a consolidated thermoplastic polymer monolith having a deformable surface formed by a first thermoplastic polymer, and a deformation-resistant region formed by fibers of a second thermoplastic polymer.

### BACKGROUND

The present invention relates to a thermoplastic polymer structure providing both a deformable sealing portion and a deformation-resistant portion. Aspects of the present invention provide particular advantages for dynamic seals used in high pressure applications, such as one-piece extrusion resistant dynamic seals made from consolidated thermoplastic polymers providing both a deformable sealing surface and an extrusion-resistant region.

Ultra-high molecular weight polyethylene (also referred to UHMWPE) is a linear high-density polyethylene (HDPE) with a molecular weight typically in the range of between 1×10⁶ to 16×10⁶. Its ultra-high molecular weight imparts exceptional impact strength and abrasion resistance as well as special processing characteristics. These unusual properties preclude the use of conventional extrusion and molding techniques.

UHMWPE is a good material for making high pressure seals because of its low friction characteristics and deformability to achieve a good seal, particularly for dynamic seals. Stock material is produced by sintering a powder form of the UHMWPE raw material into a machineable shape, such as a cylindrical rod. The stock material is then machined into high pressure seals. Properties of the cylindrical rods can be improved by pultrusion. Yet, a primary failure mechanism for machined high pressure seals remains failure by extrusion of the seal, particularly when used in a high pressure pump operated with warm inlet water temperatures. For example, seals in high pressure pumps operate in an environment of inlet water temperatures of about 100° F. and water pressures as high as 4,000 atmospheres. Seals machined from such UHMWPE stock material have a use life of about 15 hours in this environment before failure due to extrusion.

In a high pressure pump, a ceramic plunger acting as a piston is reciprocated through a UHMWPE seal to compress water in a compression chamber. The seal is retained against movement by a steel backup ring. The backup ring fits closely to the plunger with a very fine gap, which ideally is less than 0.001 inch. The pressure in the compression chamber may be as high as 4,000 atmospheres, and the seal resists movement of the high pressure water along the plunger. However, the high pressure extrudes the seal through this very fine gap. Water temperatures above 80° F. aggravate this tendency because the warm water tends to soften the UHMWPE seal. The portion of the seal proximate to the gap between the steel backup ring and the plunger is subject to extrusion, and must be reinforced to limit extrusion.

Recent patents have described methods for producing high-strength UHMWPE materials made by consolidating fibers of a single thermoplastic polymer. These patents include U.S. Pat. No. 6,132,657, for PROCESS FOR PRODUCING POLYMERIC MATERIALS, issued Oct. 17, 2000, to Cohen et al.; and U.S. Pat. No. 6,482,343, for POLYMERIC MATERIALS AND PROCESS FOR PRODUCING SAME, issued Nov. 19, 2002, to Cohen et al.; both of which are incorporated herein for all purposes.

Attempts were made to machine these high-strength UHMWPE materials to produce a high pressure seal having both a deformable portion for sealing against the plunger and an extrusion-resistant portion to resist extrusion through the very fine gap between the backup ring and the plunger. These attempts were unsuccessful because the high-strength UHMWPE material is extremely difficult to machine. In the first attempt, a piece of armor-plate, high-strength UHMWPE material made according to U.S. Pat. No. 6,132,657 was purchased and a seal machined from it. The machining operation was done with great difficulty and individual fibers were torn from the plate, leaving a rough and unsatisfactory seal that quickly failed by separation of the fibers.

In view of the foregoing, there is a need in the art for a new and improved article of manufacture having a deformable sealing portion and a deformation-resistant portion made from thermoplastic polymer materials, and a method for making such articles. In particular, there is a need for high pressure dynamic seals made from a thermoplastic polymer structure providing both a deformable sealing portion and an extrusion-resistant portion, and method of making such structures.

### SUMMARY

An embodiment of the present invention provides an extrusion-resistant seal. The seal includes a sealing part formed by melting and solidifying a first thermoplastic polymer, and an extrusion-resistant part formed by sintering a second thermoplastic polymer. The sealing part and the extrusion-resistant part may be consolidated into a one-piece structure. The second thermoplastic polymer includes fibers of the second thermoplastic polymer, which may include an oriented configuration, such as a woven configuration or a braided configuration. The sealing part has a first deformation value, and the extrusion-resistant part may have a second deformation value that is less than the first deformation value.

Another embodiment of the present invention provides an extrusion-resistant dynamic seal. The seal includes a body having two opposed ends, a deformable sealing portion formed by melting and solidifying a first thermoplastic polymer, and an extrusion-resistant region proximate to at least one of the two opposed ends and formed by sintering fibers of a second thermoplastic polymer. The seal may further include a passage extending between the two opposed ends, a portion of the passage including the deformable sealing portion. The fibers of the second thermoplastic polymer may include an oriented configuration, such as a woven configuration or a braided configuration. The sealing portion may have a first deformation value, and the extrusion-resistant region may have a second deformation value that is less than the first deformation value.

A further embodiment of the present invention provides an extrusion-resistant dynamic seal. The seal includes a sealing region having a deformable sealing region formed by a first thermoplastic polymer, and an extrusion-resistant region including fibers of a second thermoplastic polymer. The extrusion-resistant region is consolidated with the sealing region and made by a process including applying a deformation pressure to the first thermoplastic polymer and the fibers of the second thermoplastic polymer sufficient to deform the fibers of the second thermoplastic polymer to substantially fill a majority of voids in the fibers of the second thermoplastic polymer, the fibers of the second thermoplastic polymer having a melting temperature at the deformation pressure greater than a melting temperature of the first thermoplastic polymer at the deformation pressure. The process further includes heating the first thermoplastic polymer and the fibers of the second thermoplastic polymer to a temperature above the first thermoplastic polymer melting temperature and below the melting temperature of the fibers of the second thermoplastic polymer, but at which the fibers of the second thermoplastic polymer would at least partly melt at a transition pressure lower than the deformation pressure. The process further includes subsequently reducing the applied pressure to the transition pressure while maintaining the first thermoplastic polymer and the fibers of the second thermoplastic polymer at the temperature for a time sufficient for the fibers of the second thermoplastic polymer to at least partly melt, thereby substantially filling a remainder of the voids in the extrusion-resistant region. The process may include subsequent to the reduction of the applied pressure to the transition pressure, increasing the applied pressure to a consolidation pressure at least about as great as the deformation pressure while maintaining said assembly at the temperature. A physical form of the first thermoplastic polymer may be selected from the group consisting of a liquid, a powder, beads, a tape, chips, and discs. The first thermoplastic polymer may comprise a UHMWPE, for example, polyethylene having a molecular weight above one million. The fibers of the second thermoplastic polymer may include UHMWPE, and may further include fibers having an oriented configuration, such as a braided configuration. The sealing region may have a first deformation value, and the extrusion-resistant region may have a second deformation value that is less than the first deformation value.

A further embodiment of the invention includes a process for producing an extrusion-resistant dynamic seal. The process includes the steps of placing a first thermoplastic polymer in a first portion of a mold and fibers of the second thermoplastic polymer in a second portion of the mold, and applying a deformation pressure to the first thermoplastic polymer and the fibers of the second thermoplastic polymer sufficient to deform the fibers of the second thermoplastic polymer to substantially fill a majority of voids in the fibers of the second thermoplastic polymer, the fibers of the second thermoplastic polymer having a melting temperature at the deformation pressure greater than a melting temperature of the first thermoplastic polymer at the deformation pressure. The process further includes heating the first thermoplastic polymer and the fibers of second thermoplastic polymer to a temperature above the first thermoplastic polymer melting temperature and below the melting temperature of the fibers of the second thermoplastic polymer, but at which temperature of the fibers of the second thermoplastic polymer would at least partly melt at a transition pressure lower than the deformation pressure. The process also includes subsequently reducing the applied pressure to the transition pressure while maintaining the first thermoplastic polymer and the fibers of the second thermoplastic polymer at the temperature for a time sufficient for fibers of the second thermoplastic polymer to at least partly melt, thereby substantially filling a remainder of the voids in the extrusion-resistant region.

These and various other features as well as advantages of the present invention will be apparent from a reading of the following detailed description and a review of the associated drawings.

### BRIEF DESCRIPTION OF THE DRAWINGS

The features of the present invention which are believed to be novel are set forth with particularity in the appended claims. Aspects of the invention, together with further objects and advantages thereof, may best be understood by making reference to the following description taken in conjunction with the accompanying drawings, in the several figures of which like referenced numerals identify like elements, and wherein:

FIG. 1 illustrates a perspective view of an extrusion-resistant dynamic seal, according to an embodiment of the invention;

FIG. 2 illustrates a cross-sectional view of the seal of FIG. 1, according to an embodiment of the invention;

FIG. 3 illustrates a cross-section view of a mold for producing a consolidated thermoplastic polymer structure providing both a deformable sealing portion and a deformation-resistant portion, according to an embodiment of the invention;

FIG. 4 illustrates a cross-section view of the mold of FIG. 3 with a powder of a first thermoplastic polymer placed in the first molding region and fibers of a second thermoplastic polymer placed in the second molding region, according to an embodiment of the invention;

FIG. 5 illustrates a cross-section view of the mold of FIG. 4 with the sleeve applying an axial pressure to the first and second thermoplastic polymers in the mold, according to an embodiment of the invention; and

FIG. 6 illustrates a computer-screen shot of the temperature/pressure profile of the third example, according to an embodiment of the invention.

### DETAILED DESCRIPTION

In the following detailed description of exemplary embodiments of the invention, reference is made to the accompanying drawings, which form a part hereof. The detailed description and the drawings illustrate specific exemplary embodiments by which the invention may be practiced. These embodiments are described in sufficient detail to enable those skilled in the art to practice the invention. It is understood that other embodiments may be utilized, and other changes may be made, without departing from the spirit or scope of the present invention. The following detailed description is therefore not to be taken in a limiting sense, and the scope of the present invention is defined by the appended claims.

Aspects of the present invention provide a thermoplastic polymer article of manufacture having both a deformable portion and a deformation-resistant portion. These aspects are described herein by reference to an embodiment providing an extrusion-resistant dynamic seal for use in high pressure pumps where presence of both a deformable sealing region having a low friction surface and an extrusion-resistant region extend the operating life of such seals. However, articles of manufacture made according to aspects of the instant invention are not limited to seals. For example, a prosthetic hip requires a ball having both a low friction surface to move over a low friction surface of a socket, and a deformation-resistant portion to transfer loads between a leg bone joined to the ball and a hip joined to the socket. This detailed description first describes an embodiment providing an extrusion resistant dynamic seal for use in high pressure pumps, and then describes a process for making the seal.

A low friction surface as used herein generally means a surface having a sliding-friction coefficient of approximately 0.2 or less at normal atmospheric pressure.

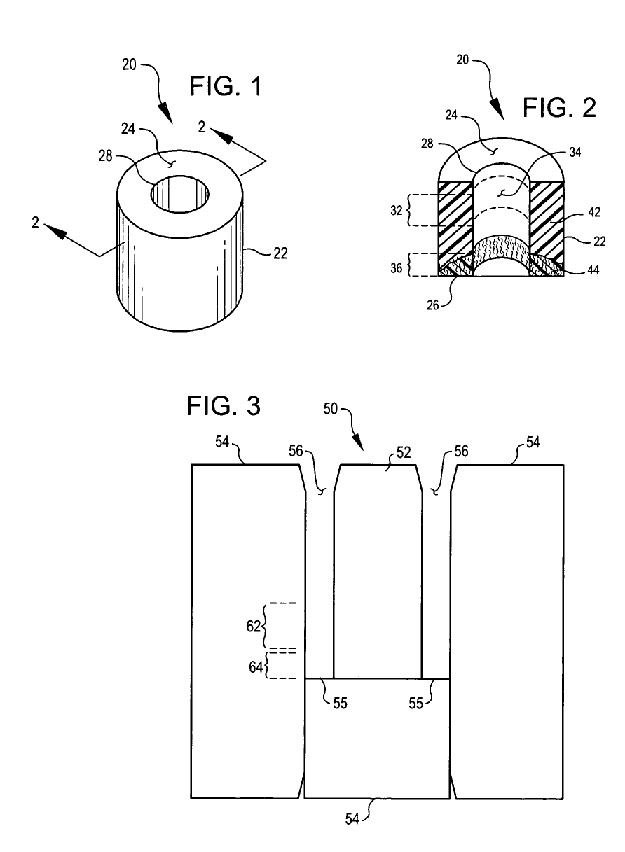

FIG. 1 illustrates a perspective view of an extrusion-resistant dynamic seal 20, according to an embodiment of the invention. FIG. 2 illustrates a cross-sectional view of the seal 20 of FIG. 1, according to an embodiment of the invention. Seal 20 includes a cylindrical body 22 having a high pressure end 24, a retention end 26, and a cylindrical passage 28 between the ends 24 and 26. The passage 28 includes a deformable sealing region 32 having a low friction surface 34, and an extrusion-resistant region 36 formed by fibers of a second thermoplastic polymer 44 proximate to and including at least a portion of the retention end 26.

Typically, a reciprocating plunger (not shown) passes through the passage 28 and compresses water in a compression chamber (not shown) proximate to the high pressure end 24. The seal 20 at the retention end 26 is retained and supported by a backup ring (not shown) that fits closely with the plunger. However, the passage 28 in order to form a seal in the deformable sealing region 32 at the low friction surface 34 fits even more closely with the plunger, leaving a portion of the retention end 26 in effect not supported by the backup ring. The high pressure water from the compression chamber exerts pressure on the high pressure end 24. This pressure is transferred through the body 22 to the retention end 26, the unsupported portion (not shown) of which is extruded over time between the plunger and the backup ring.

For improved high pressure pump start-up and increased operating life, the seal 20 should be deformable to further narrow a space or tolerance between the plunger and the seal. This deformable narrowing may occur in the deformable sealing region 32 at the low friction surface 34. The narrowing may be provided by preloading the seal 20 with a captured “O” ring (not shown) around an outer periphery of the high pressure end 24 to deform the deformable sealing region 32 and hold it firmly against the plunger, thus eliminating the space or tolerance between the plunger and low friction surface 34 for improved start-up. Further, the narrowing may be provided during operation by a thin lip (not shown) on the high pressure end 24 and proximate to the plunger. The thin lip will translate a portion of the high pressure water into a deformation force that narrows the deformation region 32, thus, narrowing the space or tolerance between the plunger and the low friction surface 34 during operation and squeezing the seal 20 against the plunger.

The deformable sealing region 32, with low friction surface 34, includes a first thermoplastic polymer 42 that has been melted and solidified during the making of the seal 20. Melting and solidifying the first thermoplastic polymer 42 produces a material having a first deformation unit value. Melting and solidifying the first thermoplastic polymer 42 further produces the low friction surface 34 having a low friction coefficient, with a friction coefficient for an UHMWPE that is generally less than 0.10, and typically 0.05 or less. When the seal 20 is fully under pressure in a high pressure pump, the friction coefficient of the low friction surface 34 further decreases.

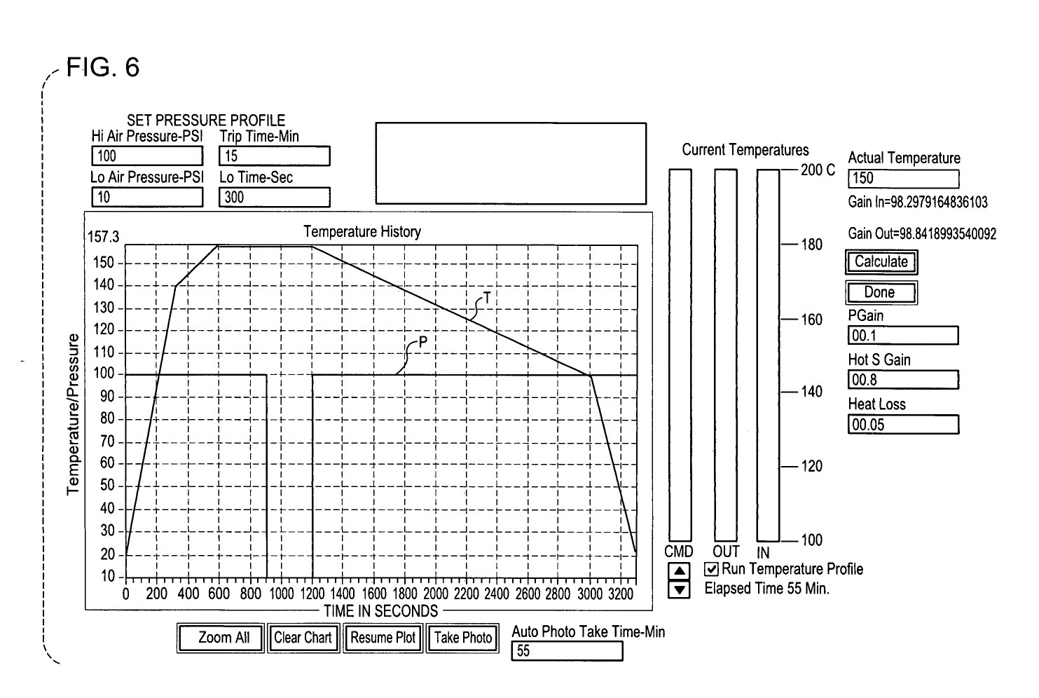

For improved seal life, the retention end 26 should significantly resist deformation so that it resists extrusion between the plunger and the backup ring, that is, it should be extrusion resistant. The extrusion-resistant region 36 of the passage 28 and the retention end 26 includes sintered fibers of a second thermoplastic polymer 44 that reinforce and resist extrusion of the retention end 26 between the backup ring and the plunger. The fibers of the second thermoplastic polymer 44 are illustrated in FIG. 2 as visible for illustration purposes. However, as explained in conjunction with Example 3 and FIG. 6, the fibers cannot clearly be seen after sintering. Sintering the fibers of the second thermoplastic polymer 44 produces the extrusion-resistant region 36 with a unit deformation value that is lower the deformation value of deformable sealing region 32. In other words, for a given applied force or load, the extrusion-resistant region 36 will lengthen or shorten less than the deformable sealing region 32. Sintering the fibers of the second thermoplastic polymer 44 further produces a low friction surface of the extrusion-resistant region 36, with a friction coefficient similar to the low friction surface 34.

While the seal 20 is illustrated configured with the cylindrical passage 28 for sealing a reciprocating, round plunger of a high pressure pump, the plunger and the corresponding passage 28 may be of any cross-sectional shape. Furthermore, the seal 20 may be configured to operate with its outer periphery having the low friction surface 34 and no passage 28. Such a seal may be mounted on a compression-chamber face of the plunger with the outer periphery of the seal having the low friction surface and sealing against a cylinder of the pump.

In an alternative embodiment not illustrated, the seal 20 may be an assembly of two separate parts. A first part includes the deformable sealing portion 32 having the low friction surface 34 formed by the first thermoplastic polymer 42 that has been melted and solidified during the making of the first part. A second part includes the extrusion-resistant portion 36 and the retention end 26 formed by the sintered fibers of a second thermoplastic polymer 44. The two parts are then associated before placement in the high pressure pump, or associated when mounted in the pump.

FIG. 3 illustrates a cross-section view of a mold 50 for producing a consolidated thermoplastic polymer structure providing both a deformable sealing portion and a deformation-resistant portion, according to an embodiment of the invention. The mold 50 is configured for producing the cylindrically shaped high pressure seal 20 illustrated in FIG. 1 having a deformable sealing part with a low friction surface and an extrusion-resistant part. However, the mold 50 may have any molding cavity shape appropriate to mold a desired article of manufacture.

The mold 50 includes a center body 52, an outer housing 54, a sleeve 58 (shown in FIG. 5) and a molding cavity 56 left between the outer housing 54 and the center body 52, the molding cavity 56 including a fixed, end surface 55. The molding cavity includes a first molding region 62 and a second molding region 64. The outer periphery of the center body 52 forms the passage 28, and the low friction surface 34 of the seal 20. The shape and diameter of the center body 52 include dimensional control for molding the seal 20 at a selected tolerance.

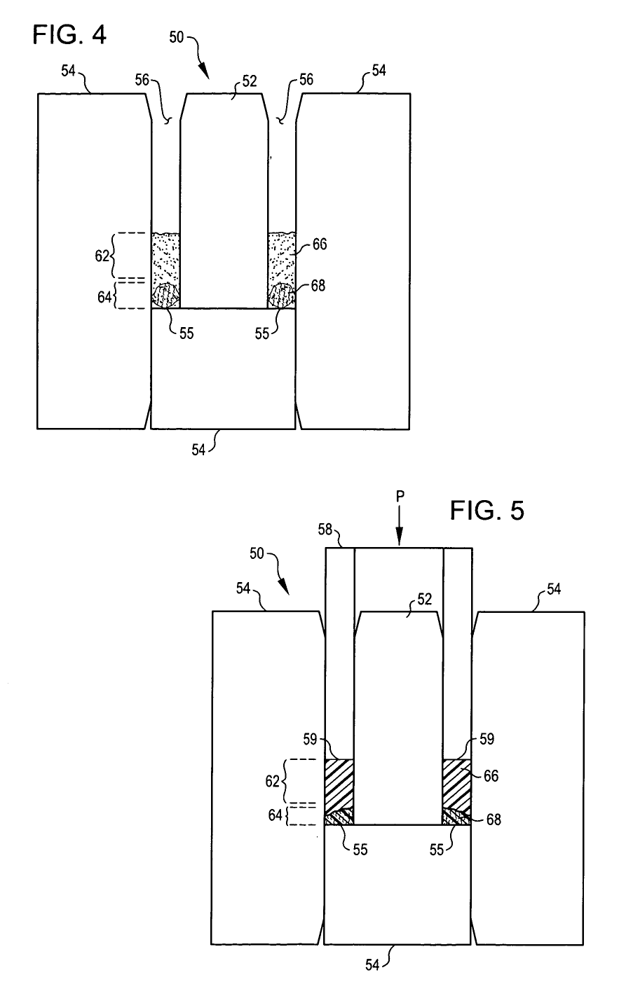

FIG. 4 illustrates a cross-section view of the mold 50 of FIG. 3 with a powder of a first thermoplastic polymer 66 placed in the first molding region 62 and fibers of a second thermoplastic polymer 68 placed in the second molding region 64, according to an embodiment of the invention.

As described in additional detail below, an aspect of the invention achieves a consolidated structure having both a deformable sealing region with a low friction surface and deformation-resistant or extrusion-resistant region by using thermoplastic polymers having different melting temperatures. The regions themselves are consolidated, and the two regions adhere to each other as a result of the same process that consolidates each region. The different melting temperatures may be achieved several ways, including using structurally different thermoplastic polymers, and using a structurally similar thermoplastic polymer in different physical forms that have different melting temperatures. For example, if a single thermoplastic polymer is used, one physical form may be powdered and another physical form may be fiber. For the purposes of describing an embodiment, a single thermoplastic polymer is used in different physical forms.

The first thermoplastic polymer 66 starting material has a physical form such as, but not limited to, a powder, beads, a tape, chips, discs, and the like, having a first thermoplastic polymer melting temperature at a deformation pressure. The physical forms of polymeric powder, beads, tape, chips, and discs have an inherently random polymer orientation.

The second thermoplastic polymer 68 starting material is preferably fibers, although the described manufacturing process may equally be applied to other physical forms of the second thermoplastic polymer. The fibers of the second thermoplastic polymer 68 have a second thermoplastic polymer melting temperature at a deformation pressure that is greater than the first thermoplastic polymer 66 melting temperature. The fibers of the second thermoplastic polymer 68 may be oriented in a variety of configurations. In particular, the fibers may be arranged as an uniaxially aligned bundle, a woven bundle of fibers, such as a yarn or braided line, a twisted bundle of fibers, an assembly of chopped fibers, a mat of interwoven bundles, or as a mat formed by layering bundles of fibers so that the bundles in successive layers are aligned at an angle to each other, e.g., perpendicular to each other. The bundles may be assembled and pressed into any convenient shape. In an embodiment, the fibers are woven into a braided configuration.

The articles of manufacture and processes of the present invention may utilize any polymer fibers that can be selectively melted. The susceptibility of particular polymers and particular grades of those polymers to selective melting varies, and their suitability for use in the process of this invention may be determined empirically. Aspects of the present invention find particular application in the production of polyolefin articles, especially polyethylene articles. Other classes of polymer fibers to which the present invention are applicable include unsubstituted or mono- or poly-halo-substituted vinyl polymers, unsubstituted or hydroxy-substituted polyesters, polyamides, polyetherketones, and polyacetals.

Returning to FIG. 4, in an embodiment of the invention for producing the extrusion-resistant dynamic seal 20, fibers of the second thermoplastic polymer 68 are placed in the second molding region 64 and proximate to the fixed-end surface 55. The first thermoplastic polymer 66 is placed in the first molding region 62 and proximate to the fibers of the second thermoplastic polymer 68. A UHMWPE powder provides good results when used for the first thermoplastic polymer 66, and woven or braided fibers of UHMWPE provide good results when used for the second thermoplastic polymer 68.

In an alternative embodiment, a substance may be placed between the first thermoplastic polymer 66 and the second thermoplastic polymer 68 to space the polymers apart, provide a structural component, or provide other features to the seal 20 such as a molecular barrier layer. Similarly, a substance may be placed on top of the first thermoplastic polymer 66 for the same reasons. It is contemplated that any such substances be arranged to consolidate with any adjacent polymers 66 and 68.

FIG. 5 illustrates a cross-section view of the mold 50 of FIG. 4 with the sleeve 58 applying an axial pressure P to the first and second thermoplastic polymers 66, 68 in the mold 50, according to an embodiment of the invention. The sleeve 58 is arranged to closely fit into the molding cavity 56, and includes a moveable end 59 that transmits the pressure P to the contents of the molding cavity 56 of the mold 50. While the surface of the moveable end 59 is illustrated as generally flat and perpendicular to the center body 52, the surface may have a shape or contour to be imparted to an end of the seal 20 during the molding process.

Once the polymers 66 and 68 are placed in the mold 50, the sleeve 58 is placed in the molding cavity 56 with the moveable end 59 proximate to the polymers. The axial pressure P may be supplied by a controllable air cylinder fitted to the sleeve 58. Further, the mold 50 is surrounded by a controllable heating apparatus, such as an electric coil.

This completes a description of the mold 50 and placing the thermoplastic polymers 66 and 68 in the mold. This description next describes a process for producing a single-piece article of manufacture having a deformable sealing region with a low friction surface and a deformation-resistant, or an extrusion-resistant, region. The process includes applying a temperature-and-pressure schedule to the thermoplastic polymer contents of the mold 50.

A process according to an embodiment of the invention for producing a consolidated one-piece structure having a deformable sealing region with a low friction surface and a deformation-resistant portion, such as the seal 20, is as follows:
1. Applying a deformation pressure to an assembly of the first thermoplastic polymer 66 and the fibers of second thermoplastic polymer 68 in the mold 50 sufficient to deform the fibers of the second thermoplastic polymer to substantially fill a majority of voids in the fibers of the second thermoplastic polymer. The deformation pressure may be applied to the polymers by a pressure applied to the sleeve 58. As previously described, the fibers of second thermoplastic polymer 68 have a melting temperature at the deformation pressure that is greater than a melting temperature of the first thermoplastic polymer 66 at the deformation pressure.
2. Heating the first thermoplastic polymer 66 and the fibers of the second thermoplastic polymer 68 to a temperature above the first thermoplastic polymer melting temperature and below the melting temperature the fibers of the second thermoplastic polymer, but at which temperature the fibers of the second thermoplastic polymer would at least partly melt at a transition pressure lower than the deformation pressure. The heat may be applied by a heating apparatus surrounding the mold 50.
3. Subsequently reducing the applied pressure to the transition pressure while maintaining the first thermoplastic polymer 66 and the fibers of the second thermoplastic polymer 68 at the temperature for a time sufficient for fibers of second thermoplastic polymer to at least partly melt, thereby substantially filling a remainder of the voids in the deformation-resistant region.

The process may include a further step of:
4. Subsequent to the reduction of the applied pressure to the transition pressure, increasing the applied pressure to a consolidation pressure at least about as great as the deformation pressure while maintaining said assembly of the first and second polymers 66 and 68 at the temperature.

### EXAMPLES

Aspects of the invention will now be described in more detail with reference to producing the one-piece, extrusion-resistant dynamic seal 20 for use in a high pressure water pump. A mold 50 was made as illustrated in FIG. 3, with the center body 52, an outer housing 54, and a sleeve 58 all made from aluminum for good heat conductivity. A controllable air cylinder was fitted to the sleeve 58, and the mold 50 surrounded by an electric heater. Sensors were fitted to these elements, and a personal computer was used to control and monitor the pressure P applied by the air cylinder to the sleeve 58 and the temperature of the outer housing 54. The thermoplastic polymers used in the examples were ultra-high molecular weight polyethylenes having a molecular weight of at least 1×10⁶.

### Example 1

In a first series of trials, chopped or unoriented fibers of an ultra-high molecular weight polyethylene (as the second thermoplastic polymer 68) were placed in the second molding region 64 proximate to the fixed-end surface 55 and at least proximate to the junction of the fixed end surface 55 and the center body 52 where extrusion typically occurs. The first molding region 62 was filled with an ultra-high molecular weight polyethylene powder (as the first thermoplastic polymer 66). The assembly of polymers 66 and 68 was processed in the mold 50 as follows:
(a) Apply 300 atmospheres. of pressure and Heat to 153° C.;
(b) Maintain at 300 atmospheres and 153° C. for 9.5 minutes;
(c) Reduce pressure to 30 atmospheres and maintain at 30 atmospheres and 153° C. for 5 minutes; and
(d) Maintain at 300 atmospheres while cooling to ambient temperature.

It was found that the degree of sintering of the chopped or unoriented fibers of the ultra-high molecular weight polyethylene could be controlled by the time at temperature and pressure applied to the material within the mold 50. However, these seals failed prematurely when the chopped or unoriented fibers forming the extrusion-resistant region separated.

### Example 2

In a next series of trials, a ⅛-inch diameter line of braided strands of SPECTRA® brand ultra-high molecular weight polyethylene fibers was used as the second thermoplastic polymer 68. The ⅛-diameter braided line used has a tensile strength of approximately one thousand pounds, and the strands each have an ultimate tensile strength of at least 10 grams/denier. A similar braided line is made of DYNEEMA® brand ultra-high molecular weight polyethylene fibers. SPECTRA® is a trademark of Honeywell, and DYNEEMA® is a trademark of DSM High Performance Fibers. The braided line was formed in a ring and placed as before in the second molding region 64 proximate to the fixed-end surface 55 and proximate to the junction of the fixed end surface 55 and the center body 52 where extrusion typically occurs. An ultra-high molecular weight polyethylene fine powder manufactured by Ticona, product number GUR4150, was used for the first thermoplastic polymer 66. A number of experiments were performed on the above assembly to sinter the braided UHMWPE fibers while melting the UHMWPE powder by varying the temperature and time at pressures. Seals having significantly improved life were produced by holding the temperature at 157.5° C. at a pressure of 267 atmospheres for most of the heating and cooling profile but with a 30-second drop to 27 atmospheres while maintaining the assembly at 157.5° C. The braid could be seen within the finished seals and by dissecting the seal, and individual strands could be separated. These seals ran with 100° F. inlet water for 70 hours before failure, and for 145 hours with 50° F. inlet water before failure. In both cases, the strands of the braid had cracked apart, but individual fibers were no longer visible.

### Example 3

In a next test, the same assembly of ⅛-inch diameter braided line of multiple strands of SPECTRA® brand ultra-high molecular weight polyethylene fibers and ultra-high molecular weight polyethylene powder manufactured by Ticona was processed with a slightly different temperature and pressure profile over time. The temperature profile was held the same as above, but the pressure was held low for 300 seconds. For seals produced with this profile, the deformable sealing part 32 having the low friction surface 34 is formed by melting and solidifying the first thermoplastic polymer 66, and may generally be visually described as translucent. The extrusion-resistant region 36 formed by sintering the fibers of the second thermoplastic polymer 68 may generally be visually described as opaque or cloudy within the finished seal 20. The braided fibers can no longer be clearly seen within the extrusion-resistant region 36, but the presence of the braided fibers can be felt when the seal is cut across the fiber orientation. It is believed the opaque or cloudy visual appearance indicates that the braided fibers of the second thermoplastic polymer have partially sintered, but retain some of the strength associated with the braided fibers from which the extrusion-resistant region 36 was formed. Testing has not been completed on these seals, but they have successfully run in a high pressure water pump for more than 130 hours with 100° F. inlet water.

FIG. 6 illustrates a computer-screen shot of the temperature/pressure profile of the third example, according to an embodiment of the invention. Temperature is illustrated as temperature T in units of degrees Centigrade at the aluminum mold 50, and pressure is illustrated as pressure P applied by the air cylinder to the sleeve 58 in relative amounts. As illustrated by FIG. 6 in the third example, the temperature-and-pressure profile over time of the assembly of polymers 66 and 68 is as follows:
(a) Apply 267 atmospheres of pressure P to the air cylinder and heat the mold 50 to a temperature T of 157.5° C.;
(b) Maintain pressure P in the air cylinder at 267 atmospheres and the temperature T in the mold 50 at 157.5° C. for 9.5 minutes;
(c) Reduce pressure P in the air cylinder to 27 atmospheres and maintain at 27 atmospheres and the temperature T in the mold 50 at 157.5° C. for 300 seconds; and
(d) Maintain pressure P in the air cylinder at 267 atmospheres while cooling to ambient temperature.

Other temperature/pressure profiles may be selected depending on the structural properties and physical forms of the thermoplastic polymers used for the assembly of polymers 66 and 68. When selecting a temperature and pressure profile for sintering the fibers of the second thermoplastic polymer 68 and for melting and solidifying the first thermoplastic polymer 66 to form a deformable sealing region, an appropriate degree of sintering for deformation resistance or extrusion resistance usually occurs when the fibers of the second thermoplastic polymer 68 are not readily observable but the region may generally be described as opaque. When the fibers or the braid are visible, then, typically, not enough sintering has occurred. When the fibers of the second thermoplastic polymer 68 are not observable and the region 36 may generally be described as translucent, then, typically, too much sintering or melting has occurred. Upon dissection of a good high pressure seal, the braid cannot be clearly seen within the extrusion-resistant region of the finished seal. It may be noticed as a cloudy appearance and the presence of the braid can be felt.

While the invention has been described with respect to a limited number of embodiments, it will be appreciated that many variations, modifications and other applications of the invention may be made. Since many embodiments of the invention can be made without departing from the spirit or scope of the invention, the invention resides in the claims hereinafter appended.

1. An extrusion-resistant dynamic seal, comprising:
(a) a sealing part comprising a solid first thermoplastic polymer; and
(b) an extrusion-resistant part comprising a mass of sintered pieces of a second thermoplastic polymer.

2. The seal of claim 1, wherein the sealing part and the extrusion-resistant part are consolidated into a one-piece structure.

3. The seal of claim 1, wherein the sealing part and the extrusion-resistant part comprise a single piece.

4. The seal of claim 1, wherein the pieces of a second thermoplastic polymer comprise fibers of the second thermoplastic polymer.

5. The seal of claim 1, wherein the first thermoplastic polymer and the second thermoplastic polymer are the same polymer.

6. The seal of claim 1, wherein the sealing part has a first deformation value, and the extrusion-resistant part has a second deformation value that is less than the first deformation value.

7. The seal of claim 1, wherein the sealing part includes a surface having a low coefficient of friction.

8. The seal of claim 7, wherein the coefficient of friction is less than approximately 0.10.

9. The seal of claim 1, wherein the first thermoplastic polymer includes ultra-high molecular weight polyethylene molecules.

10. An extrusion-resistant dynamic seal, comprising:
(a) a body having two opposed ends;
(b) a sealing region proximate to one end, comprising a solid first thermoplastic polymer; and
(c) an extrusion-resistant region proximate to the other end, comprising sintered fibers of a second thermoplastic polymer.

11. The seal of claim 10, further including;
(d) a passage extending between the two opposed ends and through the sealing region and the extrusion-resistant region.

12. The seal of claim 10, wherein the sealing region includes a surface having a low coefficient of friction.

13. The seal of claim 10, wherein the sealing region has a first deformation value, and the extrusion-resistant region has a second deformation value that is less than the first deformation value.

14. The seal of claim 10, wherein the fibers of the second thermoplastic polymer have an oriented configuration.

15. The seal of claim 10, wherein the fibers of the second thermoplastic polymer have a woven configuration.

16. The seal of claim 10, wherein the fibers of the second thermoplastic polymer have a braided configuration.

17. An extrusion-resistant dynamic seal, comprising:
(a) a sealing region having a sealing surface formed of a first thermoplastic polymer;
(b) an extrusion-resistant region including sintered fibers of a second thermoplastic polymer, the extrusion-resistant region being consolidated with the sealing region and sintered by a process including:
(i) applying a deformation pressure to the first thermoplastic polymer and the fibers of the second thermoplastic polymer sufficient to deform the fibers of the second thermoplastic polymer to substantially fill a majority of voids in the fibers of the second thermoplastic polymer, the fibers of the second thermoplastic polymer having a melting temperature at the deformation pressure greater than a melting temperature of the first thermoplastic polymer at the deformation pressure;
(ii) heating the first thermoplastic polymer and the fibers of the second thermoplastic polymer to a temperature above the first thermoplastic polymer melting temperature and below the melting temperature of the fibers of the second thermoplastic polymer but at which the fibers of the second thermoplastic polymer would at least partly melt at a transition pressure lower than the deformation pressure; and
(iii) subsequently reducing the applied pressure to the transition pressure while maintaining the first thermoplastic polymer and the fibers of the second thermoplastic polymer at the temperature for a time sufficient for fibers of the second thermoplastic polymer to at least partly melt, thereby substantially filling a remainder of the voids in the extrusion-resistant region.

18. The seal of claim 17, further comprising:
(iv) subsequent to the reduction of the applied pressure to the transition pressure, increasing the applied pressure to a consolidation pressure at least about as great as the deformation pressure while maintaining said assembly at the temperature.

19. The seal of claim 17, wherein a physical form of the first thermoplastic polymer is selected from the group consisting of a liquid, a powder, beads, a tape, chips, and discs.

20. The seal of claim 17, wherein the first thermoplastic polymer includes ultra-high molecular weight polyethylene molecules.

21. The seal of claim 20, wherein the first thermoplastic polymer includes molecules with a molecular weight above five-hundred thousand.

22. The seal of claim 20, wherein the first thermoplastic polymer includes molecules with a molecular weight above one million.

23. The seal of claim 17, wherein the fibers of the second thermoplastic polymer include molecules of an ultra-high molecular weight polyethylene.

24. The seal of claim 17, wherein the fibers of the second thermoplastic polymer have an oriented configuration.

25. The seal of claim 16, wherein the fibers of the second thermoplastic polymer include fibers formed into a strand.

26. The seal of claim 25, wherein the strand includes an ultimate tensile strength of at least 10 grams/denier.

27. The seal of claim 17, wherein the fibers of the second thermoplastic polymer include strands of the fibers braided into a line.

28. The seal of claim 17, wherein the sealing surface includes a low-friction surface.

29. The seal of claim 17, wherein the first thermoplastic polymer has been melted and solidified.

30. The seal of claim 17, wherein the sealing region after being consolidated and made has a first deformation value, and the extrusion-resistant region after being consolidated and made has a second deformation value that is less than the first deformation value.

31. A process for producing an extrusion-resistant dynamic seal, comprising the steps of:
(a) placing a first thermoplastic polymer in a first portion of a mold and fibers of a second thermoplastic polymer in a second portion of the mold;
(b) applying a deformation pressure to the first thermoplastic polymer and the fibers of the second thermoplastic polymer sufficient to deform the fibers of the second thermoplastic polymer to substantially fill a majority of voids in the fibers of the second thermoplastic polymer, the fibers of the second thermoplastic polymer having a melting temperature at the deformation pressure greater than a melting temperature of the first thermoplastic polymer at the deformation pressure;
(c) heating the first thermoplastic polymer and the fibers of the second thermoplastic polymer to a temperature above the first thermoplastic polymer melting temperature and below the melting temperature of the fibers of the second thermoplastic polymer, but at which temperature the fibers of the second thermoplastic polymer would at least partly melt at a transition pressure lower than the deformation pressure; and
(d) subsequently reducing the applied pressure to the transition pressure while maintaining the first thermoplastic polymer and the fibers of the second thermoplastic polymer at the temperature for a time sufficient for fibers of the second thermoplastic polymer to at least partly melt, thereby substantially filling a remainder of the voids in the extrusion-resistant region.

32. The process of claim 31, further comprising
(e) subsequent to the reduction of the applied pressure to the transition pressure, increasing the applied pressure to a consolidation pressure at least about as great as the deformation pressure while maintaining said assembly at the temperature.

33. A consolidated thermoplastic polymer monolith, comprising:
(a) a low-friction surface formed by a first thermoplastic polymer;
(b) a deformation-resistant region formed by fibers of a second thermoplastic polymer, the deformation-resistant region being consolidated with the a low-friction surface and made by a process including:
(i) applying a deformation pressure to the first thermoplastic polymer and the fibers of the second thermoplastic polymer sufficient to deform the fibers of the second thermoplastic polymer to substantially fill a majority of voids in the fibers of the second thermoplastic polymer, the fibers of the second thermoplastic polymer having a melting temperature at the deformation pressure greater than a melting temperature of the first thermoplastic polymer at the deformation pressure;
(ii) heating the first thermoplastic polymer and the fibers of the second thermoplastic polymer to a temperature above the first thermoplastic polymer melting temperature and below the melting temperature of the fibers of the second thermoplastic polymer but at which the fibers of the second thermoplastic polymer would at least partly melt at a transition pressure lower than the deformation pressure; and
(iii) subsequently reducing the applied pressure to the transition pressure while maintaining the first thermoplastic polymer and the fibers of the second thermoplastic polymer at the temperature for a time sufficient for fibers of the second thermoplastic polymer to at least partly melt, thereby substantially filling a remainder of the voids in the deformation-resistant region.
